(19) United States
(12) Patent Application Publication
(10) Pub. No.: US 2010/0124641 A1
(43) Pub. Date: May 20, 2010

(54) SEMICONDUCTIVE BELT AND METHOD FOR PRODUCING THE SAME

(75) Inventors: Toru Mikashima, Osaka-shi (JP); Takahiro Nakagawa, Osaka (JP)

Correspondence Address: ALLEMAN HALL MCCOY RUSSELL & TUTTLE LLP, 806 SW BROADWAY, SUITE 600, PORTLAND, OR, 97205-3335, US

(73) Assignee: TOYO TIRE & RUBBER CO., LTD., Osaka (JP)

(21) Appl. No.: 12/620,409

(22) Filed: Nov. 17, 2009

(30) Foreign Application Priority Data
Nov. 17, 2008 (JP) 2008-293702

(51) Int. Cl. B32B 25/08; B32B 27/40; B32B 27/06; B05D 3/02

(52) U.S. Cl. 428/206; 428/422; 427/393.5

(57) ABSTRACT

The present invention provides a semiconductive belt in which the generation of cracks is suppressed by enhancing conformability of a surface layer-composing coating film to the expansion and contraction of the belt while maintaining a practically required low friction coefficient, and a method for producing the same. Disclosed is a semiconductive belt including an elastic layer made of a semiconductive rubber and a surface layer, wherein the surface layer is composed of a resin layer containing a polytetrafluoroethylene resin fine powder, and a hardness-corresponding peak voltage value of the surface layer measured by a SPM (scanning probe microscope) method is −6.35V or less.

### BACKGROUND OF THE INVENTION

1. Field of the Invention

The present invention relates to a semiconductive belt which can be used as a transfer belt, a transfer conveyor belt, or the like in image forming apparatuses, using a basic principle of an electrophotographic system, such as a plain paper copying machine, a color copying machine, a laser beam printer, a facsimile and an OA instrument having a combined function thereof, and to a method for producing the same.

2. Description of the Related Art

Semiconductive belts such as a transfer belt, a transfer conveyor belt and an intermediate transfer belt used for an electrophotographic image forming apparatus are known. These semiconductive belts are provided with an elastic layer made of a rubber material such as a chloroprene rubber, NBR or an ethylene propylene rubber, and a surface layer as a lubricating layer formed, on at least a surface of the elastic layer, by applying a coating material including a resin containing a polytetrafluoroethylene fine powder (see Japanese Publication of Unexamined Application (Kokai) No. 8-160766, Japanese Publication of Unexamined Application (Kokai) No. 9-50190, Japanese Publication of Unexamined Application (Kokai) No. 11-352787 and Japanese Publication of Unexamined Application (Kokai) No. 2005-284119).

The belt disclosed in Japanese Publication of Unexamined Application (Kokai) No. 8-160766 is obtained by forming an intermediate layer on the elastic layer, and forming the surface layer thereon made of a urethane resin containing a polytetrafluoroethylene (trade name: Teflon) fine powder dispersed therein. The belt disclosed in Japanese Publication of Unexamined Application (Kokai) No. 9-50190 has the same constitution as that of the belt disclosed in Japanese Publication of Unexamined Application (Kokai) No. 8-160766, and a tetrafluoroethylene-perfluoroalkyl vinyl ether copolymer resin containing a silicone resin powder is disclosed as the surface layer-composing material. The surface layer-composing material of the belt disclosed in Japanese Publication of Unexamined Application (Kokai) No. 11-352787 and Japanese Publication of Unexamined Application (Kokai) No. 2005-284119 is a water-based resin containing a polytetrafluoroethylene fine powder, and a commercially available coating material suited for forming the surface layer with the constitution is also described.

In a transfer belt and a transfer conveyor belt, a constitution of cleaning a toner adhered on a surface using a cleaning blade or brush made of a polyurethane elastomer is usually employed so as to secure the clarity of the image and to prevent back face soiling of the paper. Therefore, there is required that the surface layer of the semiconductive belt is composed of a material having a low friction coefficient. On the other hand, since the semiconductive belt is driven by a plurality of rollers in a state where a certain tension is applied, the surface side repeatedly undergoes deformation due to the expansion and contraction at a contact portion with the roller. As a result, when the coating material as disclosed in Japanese Publication of Unexamined Application (Kokai) No. 8-160766, Japanese Publication of Unexamined Application (Kokai) No. 9-50190, Japanese Publication of Unexamined Application (Kokai) No. 11-352787 and Japanese Publication of Unexamined Application (Kokai) No. 2005-284119 is used for the surface layer of the semiconductive belt for an OA instrument, there arise such contradictory problems that fine cracks are generated on the surface as a result of long-term use when the friction coefficient is lowered, whereas, the friction coefficient increases as a result of softening by decreasing the elastic modulus of the binder resin so as to prevent the generation of cracks. Thus, it was difficult to prolong the lifetime of the belt while maintaining a low friction coefficient.

### SUMMARY OF THE INVENTION

To cope with the problems of the above known techniques, the object of the present invention is to provide a semiconductive belt in which the generation of cracks is suppressed by enhancing conformability of a surface layer-composing coating film to the expansion and contraction of a belt while maintaining a practically required low friction coefficient, and a method for producing the same.

One aspect of the present invention is a semiconductive belt including an elastic layer made of a semiconductive rubber and a surface layer, wherein the surface layer is composed of a resin layer containing a polytetrafluoroethylene resin fine powder and a hardness-corresponding peak voltage value of the surface layer measured by a SPM (scanning probe microscope) method is −6.35V or less.

Regarding the semiconductive belt with such a constitution, the generation of cracks is suppressed by enhancing conformability of a surface layer-composing coating film to the expansion and contraction of the belt while maintaining a practically required low friction coefficient. The hardness-corresponding peak voltage value measured by a SPM method is more preferably −6.40V or less. The hardness-corresponding peak voltage value measured by a SPM method is preferably −6.80V or more. Although characteristics of the surface layer-composing coating film of the belt has hitherto been evaluated merely by the measurement of the friction coefficient or hardness, it has been found that the hardness measured (SPM method) by tapping of a microprobe (cantilever) is more suited for evaluating lubricity, cleaning properties and crack resistance of the semiconductive belt such as a transfer belt.

Another aspect of the present invention is a semiconductive belt comprising an elastic layer made of a semiconductive rubber and a surface layer, wherein the surface layer has an islands-sea structure including a sea portion composed of a resin containing a polytetrafluoroethylene resin fine powder, and an island portion composed of a polyurethane resin, which is more flexible than the sea portion.

Also regarding the semiconductive belt with such a constitution, the generation of cracks is suppressed by enhancing conformability of a surface layer-composing coating film to the expansion and contraction of the belt while maintaining a practically required low friction coefficient. With such a constitution, a belt having a hardness-corresponding peak voltage value measured by a SPM method of −6.35V or less can be obtained.

In the semiconductive belt, the elongation of a dry coating film of the water-based lubricating coating material which composes the sea portion is preferably from 50 to 450%, and the elongation of a dry coating film of the water-based polyurethane resin which composes the island portion is preferably from 500 to 1,500%, in other words, the island portion-composing material is preferably more flexible than the sea portion-composing material.

When the elongation of the sea portion which composes the surface layer is more than 450%, the sea portion becomes too soft, and thus the friction coefficient of the surface layer increases. In contrast, when the elongation of the sea portion is less than 50%, the sea portion becomes too hard, and thus the generation of cracks cannot be sufficiently prevented. When the elongation of the island portion which composes the surface layer is more than 1,500%, the friction coefficient of the surface layer increases. In contrast, when the elongation of the island portion is less than 500%, although the friction coefficient decreases, the generation of cracks cannot be sufficiently prevented. A polyurethane resin with the elongation of more than 1,500% exhibits strong adhesion, and thus the toner is likely to adhere thereto. The elongation of the sea portion is more preferably from 150 to 400%, and still more preferably from 200 to 350%. The elongation of the island portion is more preferably from 600 to 1,300%.

The elongation is the value measured by a measurement method defined in JIS K 6251 with respect to a coating film after drying. The elongation of the coating film has a correlation with the hardness and the coating film generally becomes soft as the elongation increases. The hardness of the sea portion which composes the surface later is preferably from F to HB in terms of pencil hardness, while the hardness of the island portion which composes the surface layer is preferably softer than B in terms of pencil hardness.

Still another aspect of the present invention is a method for producing a semiconductive belt including an elastic layer made of a semiconductive rubber and a surface layer, the method including an elastic layer producing step of producing an elastic layer made of a semiconductive rubber and a surface layer forming step of applying a coating material for forming a surface layer on the elastic layer and drying the coating material, wherein the coating material is a mixture of a water-based lubricating coating material containing a polytetrafluoroethylene resin fine powder and a binder resin with a water-based polyurethane resin.

Regarding the semiconductive belt produced by the method with such a constitution, the generation of cracks is suppressed by enhancing conformability of a surface layer-composing coating film to the expansion and contraction of the belt while maintaining a practically required low friction coefficient. The sea portion is formed of a water-based lubricating coating material, and the island portion is formed of a water-based polyurethane resin. According to the method with such a constitution, a belt having a hardness-corresponding peak voltage value measured by a SPM method of −6.35V or less can be obtained.

In the method, a mixing ratio of the water-based lubricating coating material to the water-based polyurethane resin is such that the proportion of the island portion is preferably from 2 to 65% by weight, and more preferably from 5 to 50% by weight, in terms of the weight after drying (solid content) based on the weight of the sea portion. When the proportion of the water-based polyurethane resin is too small, the effect of preventing the generation of cracks of the surface layer decreases. In contrast, when the proportion is too large, the friction coefficient increases.

In the method for producing a semiconductive belt, the elongation of a coating film of the water-based lubricating coating material which composes the sea portion is preferably from 50 to 450%, and the elongation of a coating film of the water-based polyurethane resin which composes the island portion is preferably from 500 to 1,500%.

### DETAILED DESCRIPTION OF THE PREFERRED EMBODIMENTS

As the rubber material composing the elastic layer of the semiconductive belt of the present invention, known rubber materials, preferably polar rubbers such as a polychloroprene rubber, NBR and an epichlorohydrin rubber can be used without any limitation. The rubber material can be used without adding additives capable of imparting conductivity when the rubber material itself has desired semiconductivity. In the case of insulating rubber materials such as SBR and EPDM, and of semiconductive rubber materials which cannot be obtained by using a polar rubber material alone, known conductive fillers such as carbon black, conductive inorganic powders and ionic conductive agents are added so as to impart conductivity. Semiconductivity means that volume resistivity is from 10³ to 10¹² Ω·cm.

SPM (scanning probe microscope) is a microscope for observing a three-dimensional shape of a surface at a high magnification by scanning a sample surface while tapping with a microprobe (cantilever), and since a peak value of a voltage generated during tapping corresponds to the hardness of a surface to be measured, the hardness of the surface can be expressed by the voltage peak value.

The sea portion-composing material which composes the surface layer is composed a resin containing a polytetrafluoroethylene resin fine powder, and examples of the resin include, but not limited to, a polyurethane resin, an acrylic resin and a polyester resin. Among these resins, a polyurethane resin, an acrylic resin or a mixed resin thereof is preferred. The resin may be a non-crosslinked one, or may be crosslinked one using a crosslinking agent. The content of polytetrafluoroethylene of the sea portion after drying is preferably from 10 to 80% by weight, more preferably from 30 to 70% by weight, and still more preferably from 40 to 65% by weight. When the content of polytetrafluoroethylene is too low, lubricity of the surface layer deteriorates. In contrast, the content is too high, cracks are likely to be generated by the expansion. Although the material which composes the sea portion can be produced by dispersing a polytetrafluoroethylene resin fine powder in an aqueous solution such as an emulsion or an organic solvent solution of a resin, a commercially available coating material can also be used. Examples of the commercially available coating material include Emralon 345 and Emralon JLH-205 (Henkel Japan). Any of these commercially available coating materials are water-based lubricating coating materials which can be diluted with water, and are composed of a base resin and a curing agent, which are mixed before use.

The island portion-composing material which composes the surface layer is a polyurethane resin, and examples of a polyol compound composing the polyurethane resin include, but not limited to, a polyether-based compound and a polyester-based compound. In view of durability of the surface layer, a polyurethane resin containing a polyether-based compound, in particular, PTMG as a main polyol component (90 mol % or more based on the total polyol compound) is more preferably used. The island portion may contain a polytetrafluoroethylene resin fine powder or not.

In order to form a surface layer having a sea-island structure, it is preferred that an emulsion resin be used as a polyurethane resin which composes the island portion and a coating material prepared by mixing the emulsion resin with a water-based polytetrafluoroethylene fine powder-containing resin which composes the sea portion be used. The island portion-composing resin may have a crosslinked structure, or a non-crosslinked structure. As the water-based polyurethane resin which composes the island portion, a commercially available product can be used, and those in which the elongation of the coating film after drying is from 500 to 1,500%, and preferably from 600 to 1,300% are selected.

It is a preferred aspect that an intermediate layer or a primer layer is provided between an elastic layer and a surface layer and thus adhesion between the elastic layer and the surface layer is enhanced. As such an intermediate layer-composing material, a polyurethane resin and a halogenated polyolefin can be exemplified (see Japanese Publication of Unexamined Application (Kokai) No. 11-352787).

To the sea portion and the island portion, known additives for coating material can be added, if necessary. Examples of additives include coloring agents such as pigments and dyes, defoaming agents, leveling agents, antioxidants and ultraviolet absorbers.

### EXAMPLES

### Production Example of Elastic Layer

An unvulcanized rubber composition containing 25 parts by weight of acetylene black based on 100 parts by weight of a polychloroprene rubber, and well known materials such as processing aids, plasticizers, fillers and vulcanizing agents was prepared by a conventional method, and a belt was molded by an extrusion molding method. Using a bent type extruding machine equipped with a crosshead, a metal mandrel having an outer diameter of 102 mm and a length of 360 mm was supplied and an elastic layer having a thickness of 1.0 mm was formed on a peripheral surface of the mandrel, followed by vulcanization with heating. After cooling, the elastic layer was polished to form an elastic layer having a thickness of 0.5 mm. The elastic layer was subjected to a primer treatment.

### Example 1

Emralon 345 (Henkel Japan) including 95 parts by weight of a base resin and 5 parts by weight of a curing agent in which the content of a polytetrafluoroethylene fine powder in the solid content is 50% by weight (hereinafter referred to as a component E) and a polyurethane resin emulsion containing polyetherpolyol as a polyol component (containing no polytetrafluoroethylene fine powder; non-crosslinked one: hereinafter referred to as a component S) were mixed so that the additive amount of the solid content of the component S became 7.5% by weight based on that of the solid content of the component E to prepare a coating material for forming a surface layer. The resultant coating material for forming a surface layer was applied on a surface of the elastic layer so that the thickness of the coating film after drying became 10 μm, and then dried with heating at 120° C. for 20 minutes to form a surface layer. To the coating material, 5 parts by weight (solid content) of preliminarily water-dispersed coloring carbon black and 7.5 parts by weight (solid content) of colcothar were added, followed by dilution with water to viscosity suited for spray coating. The surface layer thus formed was observed by a microscope. As a result, the surface layer had a sea-island structure in which the island portion of the component S existed in the sea portion containing the polytetrafluoroethylene fine powder.

The elongation of the coating film formed by using Emralon 345 alone was 270% (the pencil hardness of the coating film having a thickness of 30 μm formed on an aluminum plate is from F to HB) and elongation of the coating film formed by using a polyetherpolyol-based polyurethane emulsion alone was 700% (the pencil hardness of the coating film having a thickness of 30 μm formed on an aluminum plate is 2B). Any of the elongation of the coating film is the value measured in accordance with JIS K 6251.

### Example 2

A surface layer was formed in the same manner as in Example 1, except that a coating material for forming a surface layer was prepared by mixing so that the additive amount of the solid content of the component S became 15% by weight based on that of the solid content of the component E. The surface layer thus formed was observed by a microscope. As a result, similar to Example 1, the surface layer had a sea-island structure in which the island portion of the component S existed in the sea portion containing the polytetrafluoroethylene fine powder.

### Example 3

A surface layer was formed in the same manner as in Example 1, except that a coating material for forming a surface layer was prepared by mixing so that the additive amount of the solid content of the component S became 22.5% by weight based on that of the solid content of the component E. The surface layer thus formed was observed by a microscope. As a result, similar to Example 1, the surface layer had a sea-island structure in which the island portion of the component S existed in the sea portion containing the polytetrafluoroethylene fine powder.

### Example 4

A surface layer was formed in the same manner as in Example 1, except that a coating material for forming a surface layer was prepared by mixing so that the additive amount of the solid content of the component S became 45% by weight based on that of the solid content of the component E. The surface layer thus formed was observed by a microscope. As a result, similar to Example 1, the surface layer had a sea-island structure in which the island portion of the component S existed in the sea portion containing the polytetrafluoroethylene fine powder.

### Comparative Example 1

A surface layer was formed in the same manner as in Example 1, except that only the component E was used as a coating material for forming a surface layer without adding the component S. The surface layer thus formed was observed by a microscope. As a result, the surface layer was a resin layer containing the polytetrafluoroethylene fine powder and did not have a sea-island structure.

### Comparative Example 2

A surface layer was formed in the same manner as in Example 1, except that a coating material for forming a surface layer was prepared by mixing so that the additive amount of the solid content of the component S became 75% by weight based on that of the solid content of the component E. The surface layer thus formed was observed by a microscope. As a result, similar to Example 1, the surface layer had a sea-island structure in which the island portion of the component S existed in the sea portion containing the polytetrafluoroethylene fine powder.

### Evaluation

Methods for evaluation of the coating film are as follows. The evaluation results are shown in Table 1.

### (1) Hardness of Coating Film

Using a scanning probe microscope SPM-9500 (Shimadzu Corporation), the measurement was conducted at a temperature of 23° C. Using Silicon Probe PPP-NCHR (manufactured by Nano World; C=42N/m) as a cantilever, the measurement was conducted at a measuring frequency of 1 Hz of a tapping mode in a measuring range of 10 μm×10 μm. The hardness was expressed by a peak value of the detected voltage.

### (2) Measurement of Static Friction Coefficient

With respect to a belt having a surface layer formed thereon, using Tribo Gear μs Type 94i (HEIDON), the measurement was conducted under the environment of a temperature of 23° C. and a humidity of 55% RH. As a contactor, 40 g of hard chromated brass was used.

### (3) Conformability of Coating Film

A JIS No. 1 dumbbell sample was punched out in the circumferential direction of a belt. After chucking both ends, the sample was mounted to an expansion device and then expanded at a low speed. A surface of a surface coating film was observed by a magnifying glass and the expansion ratio at which cracks occurred on the coating film was taken as conformability (%) of the coating film.

### (4) Crack Resistance

Using a belt expansion unit equipped with two rollers each having an outer diameter of 20 mm, a belt was mounted at an expansion ratio of 4% in a state of being expanded and a belt running test was conducted at a belt rotating speed of 100 rpm for 7 days. The state of a surface coating film of the belt after the test was observed by a microscope and evaluation was conducted by the presence or absence of cracks. The sample where no cracks occurred was indicated “◯”, while the sample where cracks occurred was indicated “x”.

### (5) Cleaning Properties

A commercially available black ground toner was adhered on a surface of a belt and the belt was allowed to stand at 40° C. for 48 hours. The evaluation was conducted whether or not the toner was easily scraped with a cleaning blade made of polyurethane. The sample where the toner could be easily scraped was indicated “◯”, while the sample where the toner could not be scraped and the toner was remained was indicated “x”

TABLE 1

| | Example | Example | Example | Example | Comparative | Comparative |
|---|---|---|---|---|---|---|
| | 1 | 2 | 3 | 4 | Example 1 | Example 2 |
| Additive amount | 7.5 | 15 | 22.5 | 45 | 0 | 75 |
| of S component | | | | | | |
| (% by weight) | | | | | | |
| SPM peak | −6.73 | −6.68 | −6.66 | −6.49 | −5.54 | −6.33 |
| value (V) | | | | | | |
| Conformability | 150 | 350 | >400 | >400 | 50 | >400 |
| of coating film (%) | | | | | | |
| Crack | ∘ | ∘ | ∘ | ∘ | x | ∘ |
| resistance | | | | | | |
| Static friction | 0.1 | 0.2 | 0.2 | 0.3 | 0.1 | 0.6 |
| coefficient | | | | | | |
| Cleaning | ∘ | ∘ | ∘ | ∘ | ∘ | x |
| properties | | | | | | |

As is apparent from the results shown in Table 1, the semiconductive belts having a surface layer, in which the sea portion is formed of Emralon 345 (component E), whose elongation of the coating film is 270%, and the additive amount of the solid content of a polyether-based polyurethane resin emulsion (component S), whose elongation of the coating film is 700%, is 7.5, 15, 22.5 or 45% by weight based on that of the solid content of the component E, exhibited a hardness-corresponding peak voltage value by a SPM method within a range from −6.35 to −6.80V and were excellent in conformability of the coating film and crack resistance, and also exhibited a low static friction coefficient and were excellent in cleaning properties. In contrast, the semiconductive belt having a surface layer containing no component S therein of Comparative Example 1 as the prior art exhibited a low static friction coefficient and was satisfactory in cleaning properties, but was not satisfactory in conformability of the coating film and crack resistance. On the contrary to Comparative Example 1, the semiconductive belt having a surface layer containing 75% by weight (solid content) of the component S of Comparative Example 2 was satisfactory in conformability of the coating film and crack resistance, but exhibited a high static friction coefficient and was inferior in cleaning properties. The belt having a surface layer with a static friction coefficient of 0.6 of Comparative Example 2 did not slip when abutted with a cleaning blade, and thus cleaning could not be conducted. Also when a polyether-based polyurethane resin emulsion with elongation of 1,000% was used in place of a polyether-based polyurethane resin emulsion with elongation of 700% and was added in the proportion of 22.5% by weight (solid content) based on the component E, the effect similar to that of Example 2 could be obtained.

### (Durability Test)

Using the semiconductive belt having a surface layer of Example 2 and the semiconductive belt having a surface layer of Comparative Example 1 as transfer belts, actual machine evaluation was conducted. While the number of counts up to replacement as a result of the generation of cracks on a surface was 240 k pieces (240,000 pieces) when the semiconductive belt having a surface layer of Comparative Example 1 was used, the number of counts was 500 k pieces when the semiconductive belt having a surface layer of Example 2 was used and thus the lifetime was remarkably improved.

Also in the production of the semiconductive belt, the belt is locally expanded to generate cracks on the surface layer, resulting in defects when the elastic layer is mounted to a mandrel and attached and removed after forming the surface layer by application. When one thousand belts having a surface layer of Example 2 were tentatively produced and tested, a defective rate due to the generation of cracks was 0%. In the case of the semiconductive belt having a surface layer of Comparative Example 1, the defective rate was not 2% or less in the same production process.

What is claimed is:

1. A semiconductive belt comprising an elastic layer made of a semiconductive rubber and a surface layer, wherein
the surface layer is composed of a resin layer containing a polytetrafluoroethylene resin fine powder, and
a hardness-corresponding peak voltage value of the surface layer measured by a SPM method is −6.35V or less.

2. A semiconductive belt comprising an elastic layer made of a semiconductive rubber and a surface layer, wherein
the surface layer has an islands-sea structure including a sea portion composed of a resin containing a polytetrafluoroethylene resin fine powder, and an island portion composed of a polyurethane resin, which is more flexible than the sea portion.

3. The semiconductive belt according to claim 2, wherein elongation of the sea portion is from 50 to 450% and elongation of the island portion is from 500 to 1,500%.

4. A method for producing a semiconductive belt comprising an elastic layer made of a semiconductive rubber and a surface layer, the method comprising an elastic layer producing step of producing an elastic layer made of a semiconductive rubber and a surface layer forming step of applying a coating material for forming a surface layer on the elastic layer and drying the coating material, wherein
the coating material is a mixture of a water-based lubricating coating material containing a polytetrafluoroethylene resin fine powder and a binder resin with a water-based polyurethane resin.

5. The method for producing a semiconductive belt according to claim 4, wherein a mixing ratio of the water-based lubricating coating material to the water-based polyurethane resin is such that the proportion of the water-based polyurethane resin is from 2 to 65% by weight in terms of the weight after drying (solid content) based on the weight of the water-based lubricating coating material.

6. The method for producing a semiconductive belt according to claim 4, wherein elongation of a dry coating film of the water-based lubricating coating material is from 50 to 450% and elongation of a dry coating film of the water-based polyurethane resin is from 500 to 1,500%.

7. The method for producing a semiconductive belt according to claim 5, wherein elongation of a dry coating film of the water-based lubricating coating material is from 50 to 450% and elongation of a dry coating film of the water-based polyurethane resin is from 500 to 1,500%.
